(19) United States
(12) Patent Application Publication
(10) Pub. No.: US 2007/0157218 A1
(43) Pub. Date: Jul. 5, 2007

(54) Disk drive having a disk turning mechanism, and method of turning over a disk

(75) Inventors: Coen Adrianus Verschuren, Eindhoven (NL); Martinus Bernardus Van Der Mark, Eindhoven (NL); Nicolaas Lambert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,970

(22) PCT Filed: Feb. 4, 2005
(86) PCT No.: PCT/IB05/50470

§ 371 Date: Aug. 15, 2006

(30) Foreign Application Priority Data
Feb. 17, 2004 (EP) 04100621.4

(51) Int. Cl. G11B 17/04

(52) U.S. Cl. 720/603

(57) ABSTRACT

A disk drive comprises a turning mechanism (3 to 8) adapted to provide a pulse to the side of the disk (D) resting on a tray (2) in a position outside the center so as to provide an upward and rotating movement to the disk in order to turn it over. The turning mechanism may include a pulse member (3) acting directly on the disk. In an embodiment, the turning mechanism is pneumatic, the pulse member being a nozzle adapted to direct a pressurized gas pulse at the disk. Tests have shown that exerting an eccentric pulse on the disk results in flipping the disk over reliably and quickly.

### BACKGROUND OF THE INVENTION

1. Field of the Invention

The invention relates to a disk drive comprising a disk engaging member connected to a drive shaft for engaging and rotating the disk during operation, and a tray for supporting the disk when out of engagement with the disk engaging member. The invention also relates to a method of turning over a disk positioned on a tray in a disk drive.

2. Description of the Related Art

An embodiment of a disk drive having an disk turning mechanism is disclosed in U.S. Pat. No. 4,998,232. The turning mechanism includes an optical disk holding assembly and means for moving the holding assembly in linear and rotational manner in order to move the disk holding assembly out of the disk drive housing and to turn it over in order to turn over the disk. The disk turning mechanism is relatively complicated.

It is an object of the present invention to provide a disk drive having a new disk turning mechanism which is relatively simple so that it is attractive for use in disk drives for consumer applications.

### SUMMARY OF THE INVENTION

The invention provides a disk drive in accordance with claim 1 and a method in accordance with claim 13. The method of turning the disk over is quite simple and leads to a relatively simple disk drive. Tests have shown that exerting an eccentric pulse on the disk results in flipping the disk, more or less in a pancake fashion, which may be done in a reliable way. Flipping the disk in this way takes only little time, for example about a few tenths of a second, so that this method of turning reduces the amount of buffer memory needed to make a continuous playing and/or recording of both sides of the disk possible. This effectively doubles the capacity of the disk at only a small additional little cost. The turning mechanism may also be used for automatically writing a disk label in a special layer on one side of the disk, with the content on the other side. This writing may be effected by the same optical equipment already present in an optical recorder without any special user interaction being required.

Preferably, the tray is of the type as defined in claim 2. This is a usual means for loading and/or unloading a disk drive, and the turning mechanism according to the invention may easily be combined with such a drawer-type tray.

Preferably, the turning mechanism includes a pulse member acting directly on the disk, as claimed in claim 3. It obviates the need for a holder for the disk or the like, keeping the turning mechanism simple and keeping the weight of the parts to be turned low, i.e. only the disk, thereby minimizing the required pulse energy.

Claim 4 defines one embodiment of the disk turning mechanism according to the invention, i.e. a pneumatic embodiment. In this embodiment, the risk of damage to the disk caused by the pulse member is kept to a minimum or is even reduced to zero, while the turning mechanism can be quite simple and can also easily be combined with a tray in that a flexible line is used between the gas container and the nozzle in the embodiment as claimed in claim 5.

Several embodiments are conceivable for the pressurized gas container as defined in claim 6. In the case of a replaceable container, a pressure sensor may be used to warn the user when the container needs replacement, for example by means of an external LED, a signal to the software, an external pressure gauge, etc. If a mechanical compressor unit or pump is used to fill a container with compressed gas, it is preferable to activate the compressor to refill the container only when it is needed. In this way energy is saved. Refilling can be done after each turning of the disk, e.g. in the case of a small container, after a fixed number of turns (larger container), or when a pressure sensor indicates that the remaining pressure in the container is too low for turning the disk. A manual pump may be used to reduce the required energy and cost further. In this case a relatively large container is preferred as it is unattractive to use the pump after each turning of the disk.

An alternative embodiment is defined in claim 8. This mechanical pulse member can create the same effect as the pneumatic pulse member. Of course, care should be taken that the disk is not damaged by the impact of the mechanical pulse member. This can be ensured by selecting a proper material and shape for the pulse member and/or by contacting the disk in a position where any damage or wear will not affect the data on the disk or will not damage any part of the disk that is necessary for the correct operation of the disk drive.

A simple embodiment of the disk drive is claimed in claim 9. This spring mechanism may be energized, for example, by means of the opening or closing movement of the tray.

In the embodiments where the disk is turned from a drawer-type open tray, the turning mechanism may be triggered by the tray opening mechanism itself, either mechanically or through other means. In this case, the turning mechanism may simply always be activated when the tray is opened, or only when this is desired under the control of the control unit of the disk drive.

The method according to the invention is defined in claim 14. Preferred embodiments are defined in claims 15 to 17.

The invention further relates to a turning mechanism. The turning mechanism is defined in claim 13.

The invention will be explained in more detail with reference to the drawings showing an exemplary embodiment of the optical disk drive according to the invention in a very schematic way.

### BRIEF DESCRIPTION OF THE DRAWINGS

In the drawings:

FIG. 1 is a side view illustrating the disk turning flight when a pulse is exerted on the disk in accordance with the invention.

FIG. 2 is a very schematic side view of a part of a disk drive and a disk tray including a first embodiment of the disk turning mechanism according to the invention.

FIG. 3 is a view corresponding to that of FIG. 2, but illustrating a second embodiment of the disk turning mechanism according to the invention.

### DETAILED DESCRIPTION OF THE PRESENTLY PREFERRED EMBODIMENTS

The invention relates to a disk drive for reading and/or writing a disk D. The disk may be, for example, an optical disk of any type, for example CD, CD-ROM, DVD, BD, or the like, which are readable and/or writable. The optical disk drive is thus designed for recording and/or reproducing information on the information track of the optical disk D.

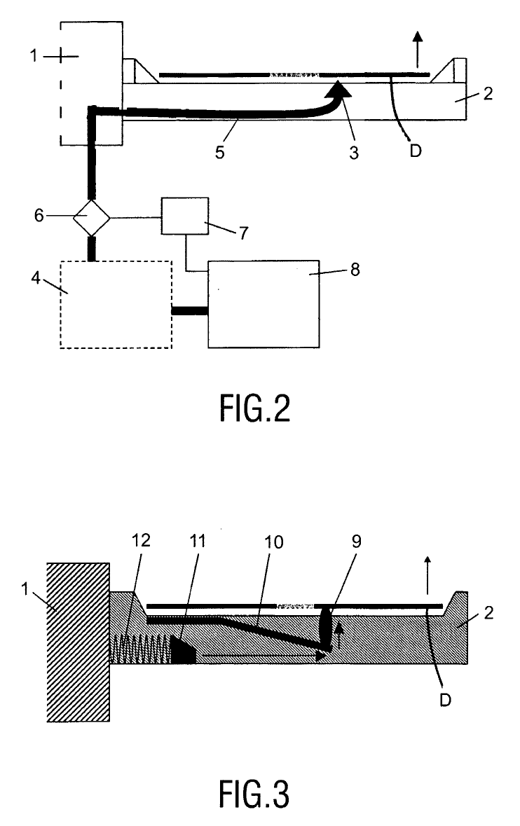

The optical disk drive comprises a housing, very schematically indicated in FIGS. 2 and 3 with reference numeral 1, for accommodating components of the disk drive. The housing 1 has a closable opening (not shown) for introducing and removing the disk D into and from the disk drive by means of a drawer-type tray 2.

For loading a disk D into the disk drive, the disk should be placed on the tray 2, normally with the side to be read or written directed to the tray. When the tray 2 is closed, the tray will substantially completely enter the housing of the disk drive 1 and, in the closed position of the tray, a disk engaging member connected to a drive shaft of the disk drive will engage the disk D in the centre thereof. Upon the start of the reading and/or writing operation of the disk drive, the motor-driven drive shaft will rotate the disk in order to allow an optical pickup unit to read data from the disk and/or write data onto the disk. A disk engaging member will normally lift the disk D from the tray 2, so that the disk is rotated freely on the disk engaging member.

In order to release the disk D again, the disk engaging member will be retracted from the disk D so that the disk D is supported again by the tray 2. In this position the tray can be opened, and this open position is shown in FIGS. 2 and 3. In this condition, the disk D can be taken out of the tray, or, in accordance with the present invention, the disk D can be turned over.

This turning of the disk D may be used, for example, in two situations. The first situation is given if the disk D can be read or written on both sides, but only one pickup unit is present. Then, the disk D should be turned to bring the other side of the disk in front of the pickup unit. The second situation is that a disk label can be written automatically in a special layer of one side of the disk, with the content data on the other side. This writing operation can be effected with the same optical equipment which is already present in the disk drive recorder and without any special user interaction being required.

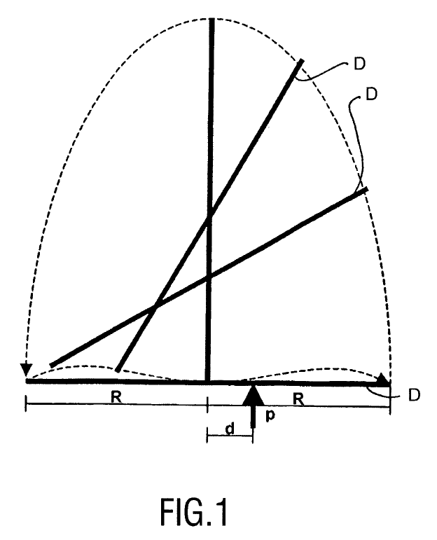

FIG. 1 illustrates the disk flight when it is turned over 180° in a pancake fashion as is illustrated, a pulse (indicated with arrow p) is exerted on the lower side of the disk at a distance d from the centre of the disk D. Due to the pulse p, the disk is lifted and rotated due to the momentum on the disk, thereby creating the pancake turning flight of the disk. This flight can be determined in a reliable manner. Preferably, the distance d for the pulse applied to a disk having a radius R is:
d=πR/16

With a pulse in this effective position, a perfect flight can be obtained in which the disk lands horizontally in a few tenths of a second with the lower edge of the disk D moving only a few millimetres from the tray 2. A “heavy” pulse (with substantially more effective mass in the pulse member than in the disk) is preferred because it makes the flight of the disk less dependent on the mass thereof. In that case only a portion of the energy and momentum of the turning mechanism is transferred to the disk.

FIG. 2 shows the principle of a first embodiment of a disk turning mechanism for the disk drive. The turning mechanism in this embodiment is pneumatic, i.e. the pulse member is a nozzle 3 which is adapted to direct a pressurized gas pulse to the disk D, which gas pulse acts directly on the disk, preferably perpendicularly to the plane of the disk. The nozzle may be mounted on the tray 2 in the correct position for obtaining a proper launch of the disk D into a flight with a 180° summersault and a nice landing. The pressurised gas is delivered by a compressed-gas storage container 4 which is connected to the nozzle 3 by a flexible gas hose 5 or the like with interposition of a valve 6 which is controlled by the central processing unit 7 of the disk drive. In this embodiment there is a compressor unit 8 which is connected to the gas container 4 in order to replenish the gas in the container 4 after one or more pulses. The gas will be normal air in this case. As an alternative, the gas container may be a disposable container such as the CO₂ modules used in professional whipped cream dispensers.

The disk turning mechanism according to the invention is very simple, and the design of a conventional disk drive does not have to be adapted substantially, if at all. The disk turning mechanism can just be added. The disk turning mechanism may be triggered by the tray opening mechanism, either mechanically or through other means, or alternatively it may be controlled by the central processing unit of the disk drive. The turning of the disk can be done quickly and efficiently with a spectacular aerobatics of the disk, which may be an attractive sight. If desired, the simple 180° summersault could even be extended to more complicated flights.

FIG. 3 shows a second embodiment of a disk turning mechanism which operates mechanically. In this case the pulse member is a mechanical pulse member 9 (more or less a hammer head) which is made to hit the disk in order to impart an impulse to the disk D, launching it into a 180° summersault flight to turn it over to its other side. The mechanical pulse member 9 may be mounted on the free end of a lever 10 as shown, and in this case a slider 11 adapted to slide along the tray is loaded by a spring member 12. When released, the loaded slider 11 will hit the lever 10 near the pulse member 9, so that the pulse member 9 receives a pulse and transfers it to the disk D. A slider locking mechanism is provided to lock the slider 11 in its starting position, which mechanism will be unlocked when a pulse is needed for turning the disk D. The spring member 12 may be loaded again during the closing movement of the tray 2, and the slider will then be automatically locked by the locking mechanism when the tray 2 arrives in its closed position. The disk turning mechanism can again be triggered by the tray opening mechanism itself in this case, either mechanically or through other means. The launch mechanism may simply be activated whenever the tray is opened, or only as required under the control of the central processing unit 7 of the disk drive.

From the foregoing it will be clear that the invention provides a disk drive having a very simple, effective, and reliable disk turning mechanism.

It is noted that in the specification and claims, the use of the expressions “a” or “an” does not exclude a plurality thereof, and the expression “comprising” does not exclude additional elements or steps. Reference signs in the claims shall not be construed as limiting the scope thereof. A single processor or unit may fulfill the functions of several elements in the appended claims.

In the presently preferred embodiments, the disk is an optical data disk. However, it should be understood that the invention may equally well be used for all kinds of other disks such as ferro-electric, magnetic, magneto-optical, near-field, active charge storage, or other disks using combinations of these techniques or other reading and/or writing techniques.

The invention is not limited to the embodiments shown in the drawing and described hereinbefore, which may be varied in different manners within the scope of the appended claims. For example, it is possible to free the space above the disk by opening or lifting a cover above the tray in order to be able to turn the disk. In this case it would not be necessary to open the tray of the disk drive or to have a drawer type tray at all. There may be more than one pulse member or a pulse member could have several points of impact. The effective point of impact should be in the desired position. For example, two points of impact could be at the edge of the disk such that the effective point of impact is at the desired distance d (appr. ¼R) from the center. Alternatively, the disk could be thrown up or launched by a mechanism that guides the initial part of the flight. The compressed gas container may be placed outside the disk drive housing. The nozzle does not necessarily have to be mounted on the tray, but could be mounted in a stationary position on the outside of the disk drive housing, such that it will be in the correct position below the tray when the tray is in its open position. The nozzle will then direct the gas towards the disk through the open tray which has a large passage opening in it anyhow. This way of mounting would also be possible with other types of impulse members, such as mechanical pulse members.

In another embodiment of the invention, the turning mechanism includes an electromechanical assembly for energizing the mechanical pulse member. The electro-mechanical assembly preferably comprises a pulsed electromagnet adapted to control a plunger of the pulse member.

1. A disk drive comprising a disk engaging member connected to a drive shaft for engaging and rotating the disk (D) during operation and a tray (2) for supporting the disk when out of engagement with the disk engaging member, and further comprising a turning mechanism (3 to 8; 9 to 12) adapted to provide a pulse to the side of the disk resting on the tray and in a position outside its center so as to provide an upward and rotating movement to the disk in order to turn it over.

2. The disk drive of claim 1, wherein the tray (2) is of the drawer type and is displaceable between a closed position within a housing (1) of the disk drive and an open position projecting outside the housing, the turning mechanism (3 to 8; 9 to 12) being adapted to be activated only when the tray is in its open position.

3. The disk drive of claim 1, wherein the turning mechanism (3 to 8; 9 to 12) includes a pulse member (3; 9) that acts directly on the disk (D).

4. The disk drive of claim 3, wherein the turning mechanism (3 to 8) is pneumatic, the pulse member (3) being a nozzle adapted to direct a pressurized-gas pulse to the disk (D).

5. The disk drive of claim 4, comprising a pressurized-gas container (4) connected to the nozzle (3) and a valve (6) provided between the container and the nozzle and controlled by a control member (7).

6. The disk drive of claim 5, wherein the pressurized-gas container (4) is a pre-filled replaceable container, or a reusable container that is to be filled by a compressor unit or by a manual pump provided with the disk drive.

7. The disk drive of claim 5, wherein the tray (2) is displaceable, and the gas container (4) is connected to the nozzle (3) through a flexible line (5).

8. The disk drive of claim 3, wherein the pulse member (9) is a mechanical pulse member which is made to collide with the disk (D).

9. The disk drive of claim 8, wherein the turning mechanism (9 to 12) includes a spring mechanism (11, 12) for energizing the mechanical pulse member (9).

10. The disk drive of claim 2 , wherein the spring mechanism (9 to 12) includes a mechanical spring (12) which is coupled to the tray (2) such that it is tensioned by a closing movement of the tray.

11. The disk drive of claim 8, wherein the turning mechanism includes an electromechanical assembly for energizing the mechanical pulse member, said electromechanical assembly preferably comprising a pulsed electromagnet adapted to control a plunger.

12. The disk drive of claim 3, wherein the pulse member (3; 9) is positioned such that its pulse hits the disk (D) in at least one position, the effective point of action of which is located within ¼of the disk's radius from the centre of the disk.

13. Turning mechanism presenting the features of the turning mechanism defined in claim 1 and being thus adapted to provide a pulse to the side of a disk is a position outside its center so as to provide an upward and rotating movement to the disk in order to turn it over, and thus constructed and evidently intended for use in the disk drive as claimed in any one of the preceding claims.

14. A method of turning a disk (D) positioned on a tray (2) in a disk drive, comprising the steps of:
freeing the space above the disk, if necessary,
providing an impulse to the disk in a position outside its center so as to turn the disk over and receive it on the tray again in an upside-down position.

15. The method of claim 14, wherein, in order to free the space above the disk (D), the tray (2) is moved into a position in which the disk is located outside a housing (1) of the disk drive before an impulse is exerted on the disk.

16. The method of claim 14, wherein the pulse is provided to the disk (D) in that a pressurized gas pulse is directed at the disk, for example from a pressurized-gas container (4).

17. The method of claim 14, wherein the pulse is provided to the disk in that a mechanical pulse member (9) is made to collide with the disk.
